(19) United States
(12) Patent Application Publication
(10) Pub. No.: US 2006/0078316 A1
(43) Pub. Date: Apr. 13, 2006

(54) DISK DEVICE WITH MULTIMEDIA VIDEO INTERFACE

(76) Inventor: Chih-Wei Hu, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/162,464

(22) Filed: Sep. 12, 2005

(30) Foreign Application Priority Data
Sep. 29, 2004 (TW) 093129570

(51) Int. Cl. H04N 5/781

(52) U.S. Cl. 386/125; 386/126

(57) ABSTRACT

A disk device with a multimedia video interface has a processor to control servos to operate the disk device for picking up information signals on a disk. The processor also cooperates with a build-in MPEG interface to transform information signals into a decompressed video format for output via the multimedia video interface. The connective pins of the multimedia video interface are reset, and include many I/O functions such as image, A/D audio, control signal, ATA interface, game, microphone, and information signal. The multimedia video interface forms a specific, standard connector with simplifying pins for the disk device only so as to avoid incompatibility.

### BACKGROUND OF THE INVENTION

1. Field of the Invention

The invention relates to a disk device with a specific interface, and more particularly to the specific multimedia video interface in a disk device transmitting signal to the external product.

2. Description of the Prior Art

Due to the prompt development of multimedia technology and a disc having the features of huge memory capacity and easy preservation, they promote the exploitation of the peripheral products of the disk device, and amplify the application field of the disk device. Therefore, there are more and more many electric products with which the disk device needs to connect. Because every electric product has variant features, its character of transmitting signal is so different that the connection interface utilized by every producer is disorderly and incompatible.

As shown in FIG. 1, a prior disk device 11 usually utilizes IDE interface 12 as an I/O interface to connect with peripheral electric products, such as a computer 13. By means of a processor 111, the disk device 11 controls a servo 112 to read or write information marks on a disc 113. For example, when reading information marks, the processor 111 transforms information marks read from the disc 113 into information signals, and the information signals are transmitted to the computer 13 through the connective pins 121 of the IDE interface 12. Then, the CPU 131 having high operation efficiency cooperates with a MPEG interface 132 to decompress information signals into a video format to output and play.

However, it is known that the IDE interface 12 is the connection interface standard for a hard disc. The optical disk device continues using the IDE interface, and utilizes the spare connective pins of the IDE interface as a connection interface. Therefore, the optical disk device utilizing the IDE interface needs to comply with the regulations concluded for the hard disc. Consequently, there are many unused connective pins in the IDE interface utilized by the optical disk device, and the circuit in PCB, components, and arrangement of the optical disk device must comply with the regulations for those unused connective pins. Thus, the optical disk device not only causes wastes of manpower, material, and production cost, but the control of the disk device becomes more complicated.

Besides, each producer has its own circuit design for the disk device adaptable to various peripheral electric products, and arbitrarily adopts the usable connective pins of the IDE interface to connect to the electric product having the feature of different signals. Therefore, the products among producers become incompatible, and the cost and time of the product exploitation increase insidiously. Furthermore, the disk device needs the processor and MPEG interface of the peripheral electric product to play video, and the peripheral electric product also needs to control the disk device. The transmission complexity of the connection interface increases. Hence, the prior disk device still has many defects to overcome.

### SUMMARY OF THE INVENTION

One object of the invention is to provide a disk device with a multimedia video interface to reduce production cost and simplify the control by means of resetting the connection interface to form a specific multimedia video interface.

Another object of the invention is to provide a disk device with a multimedia video interface to enlarge adaptable flexibility and the function of the I/O interface by means of the built-in MPEG interface and the integration of control circuits in the disk device.

For achieving the above objects, the invention has a processor to control servos to operate the disk device for picking up information signals on a disk. The processor also cooperates with a build-in MPEG interface to transform information signals into a decompressed video format for output via the multimedia video interface. The connective pins of the multimedia video interface are reset, and include many I/O functions such as image, A/D audio, control signal, ATA interface, game, microphone, and information signal. The multimedia video interface forms a specific, standard connector with simplifying pins for the disk device only.

### BRIEF DESCRIPTION OF THE DRAWINGS

FIG. 1 (Prior Art) is a block diagram of connection according to a prior disk device.

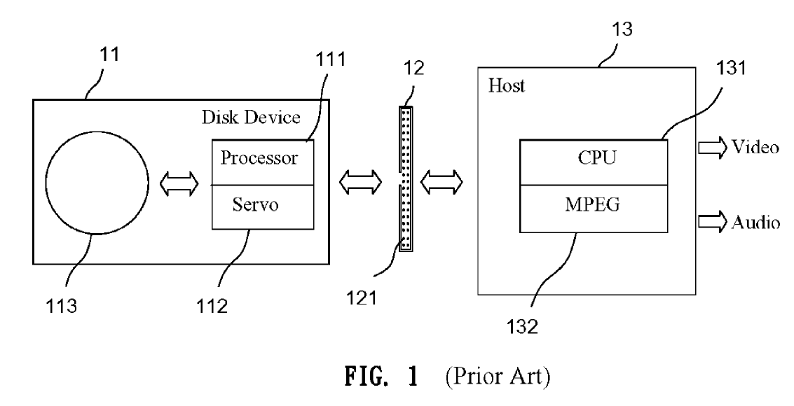

FIG. 2 is a block diagram of the multimedia video interface according to the invention.

### DETAILED DESCRIPTION

Other objects, features, and advantages of the invention will become apparent from the following detailed description of the preferred but non-limiting embodiments. The following description is made with reference to the accompanying drawings. Anyone who is skilled in related technology would be able to understand and implement the technology accordingly.

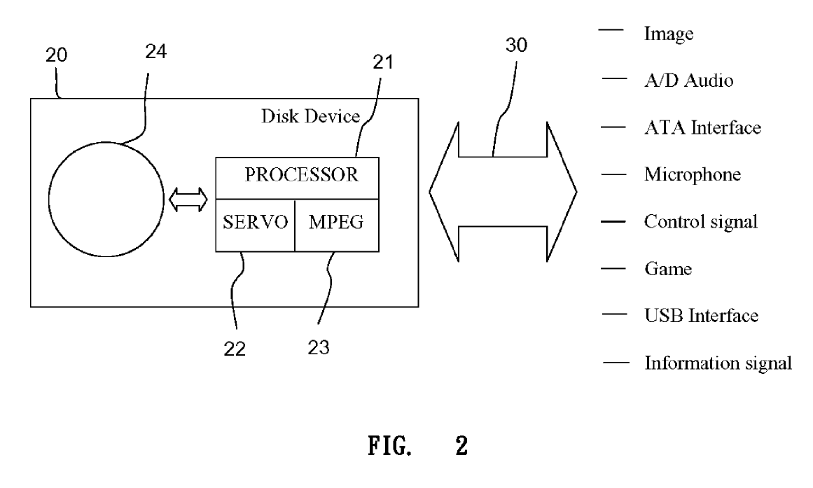

Referring to FIG. 2, the invention is a disk device 20 with multimedia video, which mainly transmits information signals read or written from a disc 24 to a connective electric product through a multimedia video interface 30.

The disk device 20 includes a processor 21, a servo 22, and a MPEG interface 23, wherein the processor 21 controls the servo 22 to read or write the information marks on the disc, and revises control signals based on the feedback signal from the servo 22 to acquire optimum, right information signals. Then, the processor 21 cooperates with the MPEG interface 23 to transform the information signals into a decompressed video format. The decompressed video format is transmitted to the connective electric product through a specific connective pin so as to generate request action, such as the play of video. Similarly, the connective electric product is also able to transmit information signals, which want to be written on the disc 24, to the disk device 20 through a specific connective pin. The processor 21 cooperates with the MPEG interface 23 to compress the information signals, and then controls the servo 22 to write on the disc 24.

Due to the integrated disk device 20, the processor 21 is able to control the servo 22 to operate the disk device 20, and meanwhile, to transform the information signals into a decompressed video format by means of the built-in MPEG interface 23. Then, the disk device 20 directly outputs video and audio signals without depending on the outfit of the connective electric product, and enlarges the scope of the adaptable flexibility. Besides, the disk device 20 release the load of the multimedia video interface 30 from transmitting huge signals, and can further simplify the multimedia video interface 30. Meanwhile, the connective electric product just needs to input operating control signals, such as play, stop, pause, backward, and forward, to the disk device 20 without other complicated control. Accordingly, the difficulty of internal control in the electric product will be reduced.

Furthermore, the IDE interface of the hard disk is able to eliminate unused connective pins and to redefine the function of each residual connective pin, such as image, A/D audio, control signal, ATA interface, video game, microphone, USB interface, and information signal, and a multimedia video connector with simpler connective pins will be formed as the specific multimedia video interface 30 for the standard of the disk device 20. Consequently, the circuit design for unused connective pins and the incompatible can be avoided, and the cost and time of the product exploitation also will be reduced.

Because the servo control and MPEG decompressed format can be completed in one disk device and the multimedia video interface 30 simplifies the standard of the connector for the disk device, the system complexity of the peripheral electric product will be lowered. The control of the disk device can also be simplified, and the multimedia video interface 30 becomes more flexible.

Those skilled in the art will readily observe that numerous modifications and alterations of the device and method may be made while retaining the teachings of the invention. Accordingly, the above disclosure should be construed as limited only by the metes and bounds of the appended claims.

what is claimed is:

1. A disk device with a multimedia video interface comprising
a disk device having a processor to control a servo and a MPEG interface for processing information signals; and
a multimedia interface transmitting the information signals, and having a plurality of connective pins only using for the function of the disk device.

2. The disk device with a multimedia video interface of claim 1, wherein the processor to control the servo to read or write the information signals on a disc.

3. The disk device with a multimedia video interface of claim 1, wherein the processor cooperates with the MPEG interface to transform the information signals into a decompressed video format.

4. The disk device with a multimedia video interface of claim 1, wherein the multimedia video interface includes the connective pins of image, A/D audio, and control signal.

5. The disk device with a multimedia video interface of claim 1, wherein the multimedia video interface includes the connective pin of an ATA interface.

6. The disk device with a multimedia video interface of claim 1, wherein the multimedia video interface includes the connective pin of a video game.

7. The disk device with a multimedia video interface of claim 1, wherein the multimedia video interface includes the connective pin of a microphone.

8. The disk device with a multimedia video interface of claim 1, wherein the multimedia video interface includes the connective pin of an USB interface.

9. The disk device with a multimedia video interface of claim 1, wherein the multimedia video interface includes the connective pin of transmitting the information signals.

10. A multimedia video interface, comprising a plurality of connective pins only using for the function of the disk device, wherein the connective pins include image, A/D audio, control signal, ATA interface, video game, microphone, USB interface, and the transmission of information signals.
